(19) United States
(12) Patent Application Publication
(10) Pub. No.: US 2024/0378711 A1
(43) Pub. Date: Nov. 14, 2024

(54) DETERMINING DYNAMIC RANGE CONVERSION PARAMETERS FROM A STATISTICAL REPRESENTATION OF AN INPUT IMAGE USING A NEURAL NETWORK

(71) Applicant: FONDATION B-COM, CESSON SEVIGNE (FR)

(72) Inventor: Foteini Tania POULI, LE RHEU (FR)

(21) Appl. No.: 18/558,876

(22) PCT Filed: May 6, 2021
(86) PCT No.: PCT/IB2021/000328

§ 371 Date: Nov. 3, 2023

(51) Int. Cl. G06T 5/90; G06V 10/60; G06V 10/75

(52) U.S. Cl. CPC G06T 5/90; G06V 10/60; G06V 10/758; G06T 2207/20084

(57) ABSTRACT

An image processing device for converting an input image having a first dynamic range into an output image having a second dynamic range distinct from the first dynamic range includes a mapping unit for transforming, using a conversion parameter, an input luminance value associated with a pixel of the input image into an output luminance value associated with the corresponding pixel in the output image. The mapping unit includes a processing module based on a neural network, the neural network being configured to receive as an input a statistical representation depending on a plurality of input luminance values respectively associated with a plurality of pixels of the input image, the neural network being configured to provide as an output the conversion parameter. A method for converting an input image into an output image is also provided.

### TECHNICAL FIELD OF THE INVENTION

The invention relates to the field of image processing.

More particularly, the invention relates to an image processing device and to a method for converting an input image into an output image.

### BACKGROUND INFORMATION

Image processing devices have been proposed for converting an input image having a first dynamic range (for instance a “Standard Dynamic Range” or SDR) into an output image having a second dynamic range (for instance a “High Dynamic Range” or HDR) that is distinct from the first dynamic range. Such a conversion is generally called “tone expansion”.

In such an image processing device, a mapping unit is provided for transforming an input luminance value associated with a pixel of the input image into an output luminance value associated with the corresponding pixel in the output image.

Usually, the mapping unit is configured to determine tone expansion parameters based on an analytical processing, for example calculation of statistics being typical of the input image.

However, this calculation of statistics is not sufficient to identify and transcribe accurately the features of the input image. The conversion may not therefore be adapted to the concerned image.

### SUMMARY OF THE INVENTION

In this context, the invention provides an image processing device for converting an input image having a first dynamic range into an output image having a second dynamic range distinct from the first dynamic range, the image processing device comprising a mapping unit for transforming, using a conversion parameter, an input luminance value associated with a pixel of the input image into an output luminance value associated with the corresponding pixel in the output image.

The mapping unit comprises a processing module based on a neural network, said neural network being configured to receive as an input a statistical representation depending on a plurality of input luminance values respectively associated with a plurality of pixels of the input image, the neural network being configured to provide as an output the conversion parameter.

Thanks to the invention, the structure of the neural network allows to map accurately the characteristics of the input image and to transcribe them into reliable parameters in order to make the conversion. Furthermore, the use of a neural network allows to adapt the conversion to different implementations and categories of input images.

Other non-limiting and advantageous features of the invention, taken individually or according to all the combinations that are technically possible, are the following:
the mapping module comprises a pre-processing module for determining the statistical representation based on counting the respective numbers of pixels of the input image associated with different luminance ranges;
the conversion parameter being an exponent, the mapping module comprises a module for exponentiating using said exponent;
the neural network is configured to provide as an additional output a peak luminance value;
the neural network is configured to provide, as the conversion parameter, a peak luminance value;
the mapping unit is configured to map a first interval of luminance values into a second interval of luminance values, whereof the peak luminance value is a supremum;
pixel values of at least one component of the input image are provided as an additional input of the neural network; and
the image processing device further comprises a training unit for training the neural network by using predetermined statistical representations associated with predetermined input images and/or corresponding conversion parameters.

The invention also provides a method for converting an input image having a first dynamic range into an output image having a second dynamic range distinct from the first dynamic range, including a step of transforming, using a conversion parameter, an input luminance value associated with a pixel of the input image into an output luminance value associated with the corresponding pixel in the output image.

The method comprises a step of determining the conversion parameter using a neural network, said neural network being configured to receive as an input a statistical representation depending on a plurality of input luminance values respectively associated with a plurality of pixels of the input image, the neural network being configured to provide as an output the conversion parameter.

Other non-limiting and advantageous features of the invention, taken individually or according to all the combinations that are technically possible, are the following:
the method further comprises a step of determining the statistical representation based on counting the respective numbers of pixels of the input image associated with different luminance ranges;
the method comprises a step of determining the statistical representation based on processing the input image by analyzing the input luminance values depending on the position of the corresponding pixels of the input image;
the step of analyzing the input luminance values comprises a step of splitting the input image into two image parts having the same sum of input luminance values;
the method further comprises, the conversion parameter being an exponent, a step of exponentiating using said exponent;
the step of determining the conversion parameter comprises a sub-step of providing a peak luminance value as an additional output of the neural network;
the step of determining the conversion parameter comprises a sub-step of providing, as the conversion parameter, a peak luminance value;
the step of determining the conversion parameter comprises a sub-step of mapping a first interval of luminance values into a second interval of luminance values, whereof the peak luminance value is a supremum;
pixel values of at least one component of the input image are provided as an additional input of the neural network; and
the method further comprises a step of training the neural network by using predetermined statistical representations associated with predetermined input images and/or corresponding conversion parameters.

### DETAILED DESCRIPTION OF EXAMPLE(S)

The following description with reference to the accompanying drawings will make it clear what the invention consists of and how it can be achieved. The invention is not limited to the embodiments illustrated in the drawings. Accordingly, it should be understood that where features mentioned in the claims are followed by reference signs, such signs are included solely for the purpose of enhancing the intelligibility of the claims and are in no way limiting on the scope of the claims.

In the accompanying drawings:

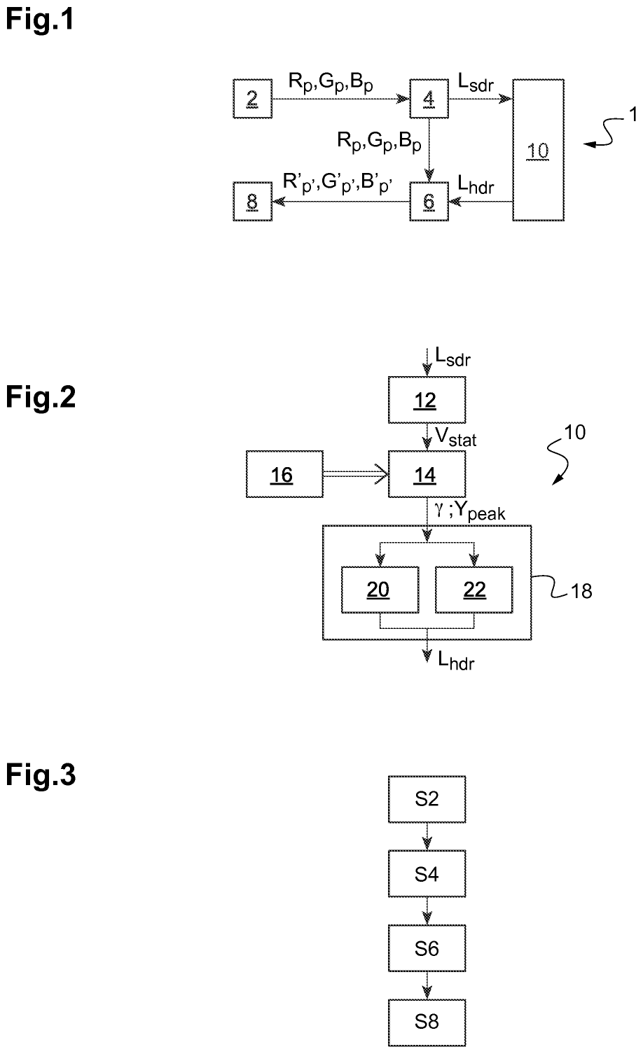

FIG. 1 shows an example of an image processing device according to the invention;

FIG. 2 shows an example of a mapping module used in the image processing device of FIG. 1;

FIG. 3 represents an exemplary flowchart of a preliminary method for training a neural network according to the invention;

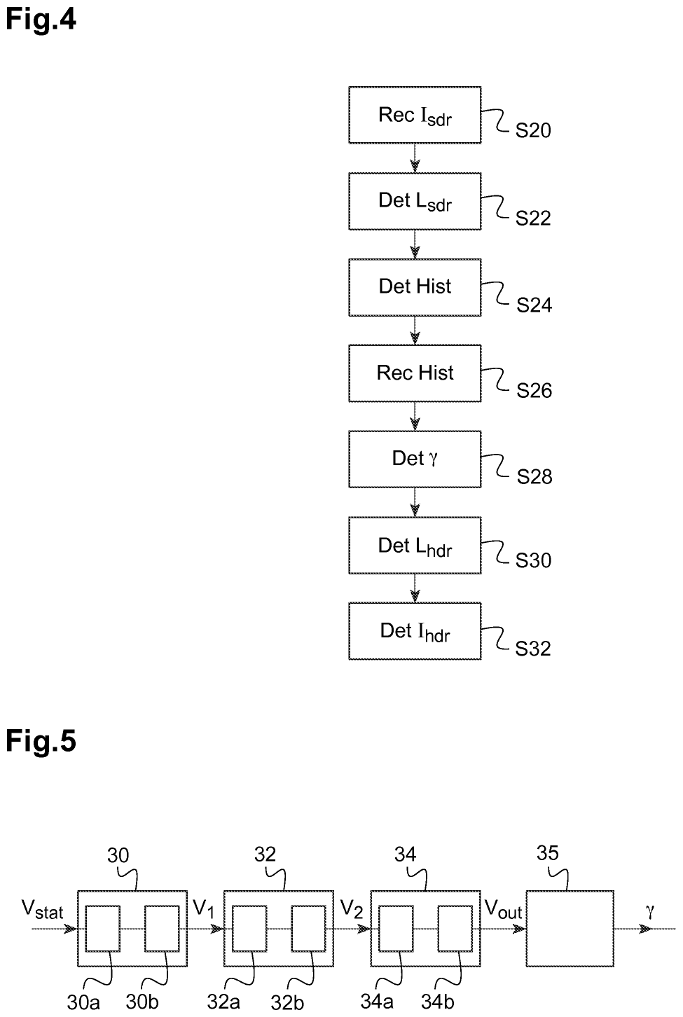

FIG. 4 shows an exemplary flowchart of a method for converting an input image according to the invention; and

FIG. 5 represents an example of a neural network used in the mapping module of FIG. 2.

FIG. 1 shows an example of an image processing device according to the invention.

This image processing device 1 may be implemented in practice by an electronic device including a processor and a memory storing program code instructions adapted to perform the operation and functions of the modules and units described below, when the concerned program code instructions are executed by the processor.

As it will be apparent from the following description, the image processing device 1 is designed to convert an input image I_{sdr} having a first dynamic range Δ_{sdr} (for instance a standard dynamic range or SDR) into an output image I_{hdr} having a second dynamic range Δ_{hdr} distinct from the first dynamic (for instance a high dynamic range or HDR),

For example here, the second dynamic range Δ_{hdr} is higher than the first dynamic range Δ_{sdr}. Such a process of converting an input image I_{sdr} having a first dynamic range Δ_{sdr} into an output image I_{hdr} having a second dynamic range Δ_{hdr} higher than the first dynamic range Δ_{sdr} is generally referred to as “tone expansion”.

As an alternative, the image processing device can be used to provide the opposite conversion, thus converting an input image having a high dynamic range into an output image a standard dynamic range. Such a process of conversion is generally referred as “tone compression”.

The input image I_{sdr} is represented, using a set of pixels (generally a matrix of pixels) of the input image I_{sdr}, by a plurality of component values Rₚ, Gₚ, Bₚ for each pixel p.

In the present example, the input image I_{sdr} is represented by three colour components Rₚ, Gₚ, Bₚ for each pixel p (namely a red component Rₚ, a green component Gₚ and a blue component Bₚ). Another representation may however be used for the input image I_{sdr}, such as for instance using a luminance component Yₚ and two chrominance components Uₚ, Vₚ for each pixel p.

As visible in FIG. 1, the image processing device 1 includes an input module 2 for receiving the input image I_{sdr}, i.e. the component values Rₚ, Gₚ, Bₚ representing the input image I_{sdr}. In practice, the component values Rₚ, Gₚ, Bₚ representing the input image I_{sdr} may be received from another module of the electronic device or from an external electronic device (through a communication circuit cooperating with the input module 2).

The image processing device 1 also includes an image preparation module 4 configured to produce (for each pixel p) an input luminance value L_{sdr} based on the component values Rₚ, Gₚ, Bₚ (of the concerned pixel p).

The image preparation module 4 may implement several steps for producing the input luminance value L_{sdr} based on the component values Rₚ, Gₚ, Bₚ, for instance in the present case:
application of an inverse Opto-Electrical Transfer Function (or OETF⁻¹);
conversion from ITU-R BT.709 standard representation to ITU-R BT.2020 standard representation;
luminance computation from the ITU-R BT.2020 standard representation.

Thanks to the step of application of the inverse Opto-Electrical Transfer Function, the input luminance value L_{sdr} produced by the image preparation module 4 represents a linear luminance component of the input image I_{sdr}.

As represented in FIG. 1, the image processing device 1 includes a mapping unit 10 designed (as further explained below) to transform the input luminance value L_{sdr} associated with any pixel p of the input image I_{sdr} into an output luminance value L_{hdr} associated with the corresponding pixel p′ in the output image I_{hdr}.

The mapping unit 10 uses at least one conversion parameter to perform this transformation. As described in the following, the conversion parameter is for example an exponent γ.

According to another embodiment, the conversion parameter can be a peak luminance value Yₚₑₐₖ. In this case, the mapping unit 10 can be configured to map a first interval of luminance values [x₀, x₁] into a second, adjustable, interval of luminance values [y₀, y₁], the supremum y₁ of the second interval of luminance values depending here on the peak luminance value Yₚₑₐₖ. Here, input luminance values L_{sdr} are normalised (i.e. represent a ratio to the maximum possible input luminance value); thus, x₀=0 and x₁=1.

An exemplary embodiment of the mapping unit 10 is described below referring to FIG. 2.

The image processing device 1 includes an image production module 6 configured to determine, for each pixel p′ of the output image I_{hdr}, component values R′_{p′}, G′_{p′}, B′_{p′} for the concerned pixel p′ based on the output luminance value L_{hdr} produced by the mapping unit 10 for the concerned pixel p′ and on the component values Rₚ, Gₚ, Bₚ relating to the corresponding pixel p in the input image I_{sdr}.

To determine component values R′_{p′}, G′_{p′}, B′_{p′} based on the output luminance value L_{hdr} and the component values Rₚ, Gₚ, Bₚ, the image production module 6 implements for instance:
a step of scaling the component values Rₚ, G, Bₚ using the output luminance value L_{hdr} (so that the scaled component values represent a colour having the output luminance value L_{hdr});
a possible step of colour correction (e.g. by saturation adjustment);
a possible step of application of an Opto-Electrical Transfer Function (or OETF).

In the present example, the component values R′_{p′}, G′_{p′}, B′_{p′} are three colour components R′_{p′}, G′_{p′}, B′_{p′} for each pixel p′ of the output image I_{hdr} (namely a red component R′_{p′}, a green component G′_{p′} and a blue component B′_{p′}). Another representation may however be used for the output image I_{hdr}, such as for instance using a luminance component Y′_{p′} (possibly equal in this case to the output luminance value L_{hdr} produced by the mapping unit 10 for the concerned pixel p′) and two chrominance components U′_{p′}, V′_{p′} for each pixel p′.

The image processing device 1 includes an output module 8 for outputting the component values R′_{p′}, G′_{p′}, B′_{p′}, for instance for use by a display module of the electronic device mentioned above to display the output image I_{hdr} on a screen of this electronic device, or, as a variation, for transmission to an external electronic device (using a communication circuit of the electronic device).

Said differently, the electronic device implementing the image processing device 1 may be a display device including a screen suitable for displaying the output image I_{hdr}. As a variation however, the electronic device may be a processing device with no display, possibly with a communication circuit for transmitting the component values R′_{p′}, G′_{p′}, B′_{p′} representing the output image I_{hdr} to an external electronic device (that may include a screen suitable for displaying the output image I_{hdr}).

FIG. 2 shows a possible embodiment of the mapping unit 10.

The mapping unit 10 comprises a pre-processing module 12, a processing module 14, a training unit 16 and an adaptive mapping module 18.

The pre-processing module 12 is configured to determine a statistical representation based on counting the respective numbers of pixels of the input image associated with different luminance ranges. In other words, the statistical representation depends on the plurality of input luminance values L_{sdr} respectively associated with a plurality of pixels p (e.g. all the pixels) of the input image I_{sdr}.

In practice here, the statistical representation is a histogram counting the respective numbers of pixels p of the input image I_{sdr} associated with different luminance ranges. In other words, the statistical representation is in this case a vector vₛₜₐₜ whose elements respectively represent the number of pixels having a given input luminance value or being included in a given range of luminance values.

In a possible embodiment, the statistical representation can be based on the analysis of the input luminance values depending on the corresponding pixels of the input image. As an example, the statistical representation may contain spatial information as well and can be obtained with the median cut method for instance. According to this method, the input image is recursively split into two image parts of equal energy, the energy, in this particular case, corresponding to the sum of luminance values within each part. In other words, the input image is split into two image parts having the same sum of input luminance values.

Using this approach for a fixed number of iterations n, will result in splitting the image into 2ⁿ segments, each containing an equal energy as measured by summing the input luminance values of each segment. The statistical representation in this embodiment can be a vector vₛₜₐₜ, where each element corresponds to one segment and encodes the location and dimensions of the segment. More details about the median cut method used on the input luminance values of the input image can be found in the article: “A median cut algorithm for light probe sampling”, de Debevec, Paul, ACM SIGGRAPH 2008 classes, 2008, 1-3.

The mapping module 10 also comprises the processing module 14. The processing module 14 is configured to determine the conversion parameter. The processing module 14 is based on a neural network. In other words, the neural network is configured to provide, as an output, the conversion parameter.

FIG. 5 represents an example of the neural network as used in the processing module 14 of the mapping unit 10.

The neural network is for example a regression network. It comprises here at least three layers 30, 32, 34. Each layer 30, 32, 34 comprises a convolution layer 30a, 32a, 34a followed by a max pooling step 30b, 32b, 34b. Using convolution layers has the advantage of making the implementation of the neural network easier.

Each layer 30, 32, 34 involves at least 16 neurons. For example here, the first layer 30 involves 16 neurons, the second layer 32 and the third layer 34 comprise 32 neurons.

The structure of the neural network involves a plurality of weights than can be adjusted, previously to the implementation of the neural network itself, thanks to a training phase as described in the following in a preliminary method (FIG. 3).

The neural network is configured to receive, as an input, the statistical representation. As an example, the histogram of the luminance ranges of the input image I_{sdr} is used as the input of the neural network. In practice, a one-dimensional vector vₛₜₐₜ representing this histogram is used as the input of the neural network. For example, the one-dimensional vector vₛₜₐₜ (also noted input vector vₛₜₐₜ in the following) used as the input of the neural network comprises at least 50 elements (in other words, the luminance values associated with the input image I_{sdr} are divided into 50 successive ranges and the corresponding histogram indexes the number of pixels in each of these 50 successive ranges).

Each convolution layer 30a, 32a, 34a is here a one-dimensional layer. Each convolution layer 30a, 32a, 34a is based on a rectified linear unit function in order to perform the regression.

Each max pooling step 30b, 32b, 34b performs a discretization step by halving the number of neurons at each layer. In practice, for each max pooling step 30b, 32b, 34b, this discretization step is achieved by comparing the neurons in twos and selecting the maximum neuron of each considered pair of neurons.

For example here, if the input vector vₛₜₐₜ is a one-dimensional vector comprising e.g. between 50 and 200 elements (here 100 elements), a first vector v₁ obtained as the output of the first layer 30 thus comprises between 25 and 100 elements (here 50 elements) due to the max pooling step 30b of the first layer 30. A second vector v₂ obtained as the output of the second layer 32 then comprises between 12 and 50 elements (here 25 elements) thanks to the max pooling step 32b of the second layer 32. Finally, an output vector vₒᵤₜ is obtained at the output of the third layer 34 and comprises between 6 and 25 elements (here 12 elements) thanks to the max pooling step 34b of the third layer 34.

The output of the third layer, namely here the output vector vₒᵤₜ (FIG. 5), is arranged in the form of a one-dimensional output vector.

As represented in FIG. 5, the neural network also comprises a final output layer 35. The output layer receives the output vector vₒᵤₜ. This final output layer 35 is configured, based on the output vector vₒᵤₜ, to use a linear function, such as an identity function in order to perform the regression and determine the conversion parameter. In other words, this final output layer 35 takes input from all the neurons and performs the final prediction of a single value, the conversion parameter. The obtained conversion parameter is for example here the exponent γ. In a variant, the obtained conversion can be another parameter, such as the peak luminance value Yₚₑₐₖ.

As an alternative, additional values can be provided as an input of the neural network. For example, the pixel values of at least one component of the input image can also be provided as an input of the neural network. In this case, a vector concatenating the histogram and the pixel values may be used as the input of the neural network. In this case, the network architecture may be deeper as the one described above, comprising more layers.

As another alternative, the neural network can be configured to provide as output two conversion parameters. For example, the neural network can provide the exponent γ and the peak luminance value Yₚₑₐₖ.

As represented in FIG. 2, the mapping module 10 also comprises the training unit 16 for training the neural network, as a pre-processing of the neural network, previously to the implementation of the neural network itself for the method for converting the input image. The training unit 16 makes use of predetermined statistical representations associated with predetermined input images and corresponding conversion parameters. The method for training the neural network is described in the following referring to FIG. 3.

Finally, in order to perform the conversion of the input image I_{sdr}, the mapping module 10 comprises the adaptive mapping module 18. The adaptive mapping module 18 is configured to produce the output luminance value L_{hdr} (for each pixel p′ of the output image I_{hdr}) based on the determined conversion parameter, for example based on the exponent γ and/or the peak luminance value Yₚₑₐₖ.

First, the adaptive mapping module 18 comprises a sub-module 20 configured to transform, for each pixel p, the input luminance L_{sdr} into an intermediate luminance Lₘ.

In the present case, the intermediate luminance value Lₘ is obtained from the input luminance value L_{sdr} by applying a function h which depends neither on the image content (i.e. neither on the pixel values of the input image I_{sdr}) nor on the peak luminance Yₚₑₐₖ: Lₘ=h(L_{sdr}). The function h may however be specifically adapted to other conditions, for instance depending on the type of display on which the output image I_{hdr} is intended to be displayed.

As an example, the intermediate luminance Lₘ can be defined as follows:

$${L}_{m} = \frac{{m}_{b} * {L}_{sdr}^{{m}_{c}^{- 1}}}{{m}_{a} - {L}_{sdr}^{{m}_{c}^{- 1}}}$$

with mₐ, m_{b} and m_{c} which are predetermined values, for example: mₐ=1.5284, mₚ=0.5279 and m_{c}=0.7997.

When the exponent γ is obtained at the output of the neural network (as the conversion parameter), the adaptive mapping module 18 comprises a module 22 configured to exponentiate the intermediate luminance value Lₘ using the determined exponent γ in order to determine the output luminance value L_{hdr}: L_{hdr}=(Lₘ)γ.

As an alternative, if the peak luminance value Yₚₑₐₖ is obtained at the output of the neural network (as the conversion parameter), the adaptive mapping module 18 can be configured to determine the output luminance value L_{hdr} in the second range of values [y₀, y₁], i.e. in particular below (or equal to) the supremum y₁, which depends on the peak luminance value Yₚₑₐₖ. The supremum y₁ is for instance proportional to the peak luminance value Yₚₑₐₖ.

In this case, the exponent γ is determined on the basis of known methods such as the ones described in the article “Tone expansion using lighting style aesthetics” de C. Bist, R. Cozot, G. Madec and X. Ducloux, Comput. Graph., vol. 62, pp. 77-86, 2017 or in the article “Evaluation of reverse tone mapping through varying exposure conditions” de B. Masia, S. Agustin, R. W. Fleming, O. Sorkine and D. Gutierrez, ACM Trans. Graph., vol. 28, no. 5, p. 1, December 2009.

The output luminance value L_{hdr} is then determined as follows: L_{hdr}=f(Yₚₑₐₖ)*(Lₘ)γ, using the determined exponent γ obtained from known methods and the peak luminance value Ypeak obtained from the neural network. The function f defines the supremum y1 as a function of the peak luminance value Yₚₑₐₖ. For example, considering a maximum value Yₘₐₓ as the maximum allowable value for the peak luminance value Yₚₑₐₖ, which may correspond for instance to the maximum luminance obtainable by the display on which the output image I_{hdr} is to be displayed, the function f can be defined as follows: f(Yₚₑₐₖ)=Yₚₑₐₖ/Yₘₐₓ.

As an example, for current HDR displays, use is made of a maximum luminance Yₘₐₓ equal to 1000 nits (i.e. 1000 cd/m²).

The invention also relates to a method for converting an input image I_{sdr} having a first dynamic range Δ_{sdr} into an output image I_{hdr} having a second dynamic range Δ_{hdr} distinct from the first dynamic range Δ_{sdr} according to the invention.

Previously to the implementation of the method for converting the input image I_{sdr}, a preliminary method is performed in order to train to the neural network used in the processing module 14. FIG. 3 represents an exemplary flowchart of this preliminary method for training the neural network.

The preliminary method for training the neural network is implemented in the training unit 16 of the mapping unit 10.

As represented in FIG. 3, the preliminary method comprises a step S2 in which the training unit 16 receives predetermined input images.

Based on these predetermined images, the training unit 16 computes the predetermined statistical representations associated with the predetermined input images (step S4). As described previously, the statistical representation is for example a histogram of luminance ranges. In this case, for each predetermined input image, a vector indicating respectively, for the various luminance ranges, the number of pixels of the concerned input image having a luminance within the concerned luminance range is determined.

The preliminary method continues with step S6 of determining, for each predetermined input image, the desired associated conversion parameter. The commonly known methods are used to determined here the associated conversion parameter. For example, in the case of an exponent γ as the conversion parameter, the exponent is calculated based on methods described in the articles previously introduced.

In a possible embodiment, the conversion parameter can be obtained manually by adjusting the corresponding value of the conversion parameter and selecting the optimal one for the concerned input image visually or based on assessment methods and criteria as described in the article “Dynamic range independent image quality assessment” de T. O. Aydin, R. Mantiuk, K. Myszkowski, and H.-P. Seidel, ACM Trans. Graph., vol. 27, no. 3, p. 1, August 2008.

At step S8, the predetermined statistical representations determined at step S4 and the associated conversion parameters determined at step S6 (each being respectively determined for the various predetermined images) are used to train the neural network using standard procedures. In other words, this step of training consists in determining the optimal weights of the neural network.

Using standard procedures used to train neural networks, the step S8 comprises a plurality of iterations (usually named epochs) in order to determine the optimal weights. In practice, at each iteration (or epoch), an error between an obtained conversion parameter and the corresponding predetermined one (obtained with conventional methods) is computed. This error is for example calculated as a mean square error.

The computed error is compared to a desired minimum error. If this desired minimum error is reached, the corresponding weights used to obtain it are then considered as the optimal weights to use to configure the neural network.

If the computed error does not match with the desired minimum error, the weights need to be adjusted. This weight adjustment can be made based on a method of optimization such as the Adam optimizer described in the article “Adam: a method for stochastic optimization” de D. P. Kingma and J. L. Ba, 2015.

After each adjustment, another iteration is performed until determining the weights that allow to reach the intended minimum error.

Once determined, the determined optimal weights are stored in order to configure the neural network in order to convert the input image I_{sdr} having the first dynamic range Δ_{sdr} into the output image I_{hdr} having the second dynamic range Δ_{hdr} distinct from the first dynamic range Δ_{sdr}.

In practice, different preliminary methods, corresponding to different trainings of the neural network, can be performed in order to match the intended application of the conversion of the input image, leading to different sets of weights respectively corresponding to the concerned applications. For example, one preliminary method can be performed for sport input images, leading to specific weights adapted to this category of images. Another preliminary method can be performed for animation input images, leading to corresponding weights.

At the end of the steps of the preliminary method shown in FIG. 3, the neural network is trained in order to be used in the method for converting the input image described in the following.

FIG. 4 shows an exemplary flowchart corresponding to a method for converting the input image I_{sdr} having the first dynamic range Δ_{sdr} into the output image I_{hdr} having the second dynamic range Δ_{hdr} distinct from the first dynamic range Δ_{sdr}.

As visible in FIG. 4, the method comprises a step S20 of receiving the input image I_{sdr}. As described previously, the input image I_{sdr} is for example represented by the component values Rₚ, Gₚ, Bₚ.

At step S22, the image preparation module 4 determines the input luminance values L_{sdr}, respectively associated with each pixel p of the input image I_{sdr}, based on the component values Rₚ, Gₚ, Bₚ.

At step S24, the pre-processing module 12 determines the statistical representation depending on the input luminance values L_{sdr} determined at step S22. For example here, the statistical representation is a one-dimensional vector based on the histogram indexing the respective numbers of pixels p associated with different luminance ranges.

The processing module 14 then receives the determined statistical representation (step S26). More particularly, the determined statistical representation applied at the input of the neural network. In a possible embodiment, pixel values of the input image I_{sdr} can be provided as an additional input of the neural network.

At step S28, the neural network provides, as the output, the corresponding conversion parameter. In this example, the conversion parameter is the exponent γ. As an alternative, the obtained conversion parameter can be the peak luminance value Yₚₑₐₖ. As another alternative, both conversion parameters, the exponent γ and the peak luminance value Yₚₑₐₖ, can be provided as the outputs of the neural network.

The adaptive mapping module 18 then produces the output luminance value L_{hdr} (for each pixel p′ of the output image I_{hdr}) based on the conversion parameter (step S30).

Finally, at step S32, the image production module 6 determines, for each pixel p′ of the output image I_{hdr}, component values R′_{p′}, G′_{p′}, B′_{p′} for the concerned pixel p′ based on the output luminance value L_{hdr} produced by the mapping unit 10 at step S30. The output image I_{hdr} having the second dynamic range Δ_{hdr} is determined thanks to the output module 8.

1. An image processing device for converting an input image having a first dynamic range into an output image having a second dynamic range distinct from the first dynamic range, the image processing device comprising:
at least one processor configured to transform, using a conversion parameter, an input luminance value associated with a pixel of the input image into an output luminance value associated with the corresponding pixel in the output image, the at least one processor being configured to perform processing based on a neural network that is configured to receive, as an input, a statistical representation depending on a plurality of input luminance values respectively associated with a plurality of pixels of the input image, the neural network being configured to provide, as an output, the conversion parameter.

2. The image processing device according to claim 1, wherein the at least one processor is configured to perform pre-processing to determine the statistical representation based on counting the respective numbers of pixels of the input image associated with different luminance ranges.

3. The image processing device according to claim 1, wherein the conversion parameter is an exponent, the at least one processor being configured to perform exponentiating using said exponent.

4. The image processing device according to claim 3, wherein the neural network is configured to provide, as an additional output, a peak luminance value.

5. The image processing device according to claim 1, wherein the neural network is configured to provide, as the conversion parameter, a peak luminance value.

6. The image processing device according to claim 4, wherein the at least one processor is configured to map a first interval of luminance values into a second interval of luminance values, whereof the peak luminance value is a supremum.

7. The image processing device according to claim 1, wherein pixel values of at least one component of the input image are provided as an additional input of the neural network.

8. The image processing device according to claim 1, wherein the at least one processor is configured to train the neural network by using predetermined statistical representations associated with predetermined input images and corresponding conversion parameters.

9. A method for converting an input image having a first dynamic range into an output image having a second dynamic range distinct from the first dynamic range, the method comprising:
determining a conversion parameter using a neural network that is configured to receive, as an input_ a statistical representation depending on a plurality of input luminance values respectively associated with a plurality of pixels of the input image, the neural network being configured to provide, as an output, the conversion parameter; and
transforming, using the conversion parameter, an input luminance value associated with a pixel of the input image into an output luminance value associated with the corresponding pixel in the output image.

10. The method according to claim 9, further comprising determining the statistical representation based on counting the respective numbers of pixels of the input image associated with different luminance ranges.

11. The method according to claim 9, further comprising determining the statistical representation based on processing the input image by analyzing the input luminance values depending on the position of the corresponding pixels of the input image.

12. The method according to claim 9, wherein the conversion parameter is an exponent, and
the method further comprises exponentiating using said exponent.

13. The method according to claim 12, wherein said determining the conversion parameter comprises providing a peak luminance value as an additional output of the neural network.

14. The method according to claim 9, wherein said determining the conversion parameter comprises providing, as the conversion parameter, a peak luminance value.

15. The method according to claim 13, wherein the determining the conversion parameter comprises mapping a first interval of luminance values into a second interval of luminance values, whereof the peak luminance value is a supremum.

16. The method according to claim 9, wherein pixel values of at least one component of the input image are provided as an additional input of the neural network.

17. The method according to claim 9, further comprising training the neural network by using predetermined statistical representations associated with predetermined input images and corresponding conversion parameters.

18. The image processing device according to claim 2, wherein the conversion parameter is an exponent, the at least one processor being configured to perform exponentiating using said exponent.

19. The image processing device according to claim 2, wherein the neural network is configured to provide, as the conversion parameter, a peak luminance value.

20. The image processing device according to claim 5, wherein the at least one processor is configured to map a first interval of luminance values into a second interval of luminance values, whereof the peak luminance value is a supremum.
